(19) United States
(12) Patent Application Publication
(10) Pub. No.: US 2007/0187394 A1
(43) Pub. Date: Aug. 16, 2007

(54) Molten metal molding machine

(75) Inventor: Yoshiya Taniguchi, Akashi-shi (JP)

Correspondence Address: CROWELL & MORING LLP;INTELLECTUAL PROPERTY GROUP, P.O. BOX 14300, WASHINGTON, DC, 20044-4300, US

(73) Assignee: Toyo Machinery & Metal Co., Ltd., Akashi-shi (JP)

(21) Appl. No.: 11/704,263

(22) Filed: Feb. 9, 2007

(30) Foreign Application Priority Data
Feb. 13, 2006 (JP) 2006-035186

(51) Int. Cl. H05B 6/10

(52) U.S. Cl. 219/639

(57) ABSTRACT

A molten metal molding machine is provided with a heating cylinder, a linear motion member for successively feeding preheated metal rods into the heating cylinder from its rear end to successively push the metal rods toward a forward end of the heating cylinder, and a heater arranged on the heating cylinder such that the metal rods are gradually molten as they move through the heating cylinder from its rear end toward its forward end. The heating cylinder, the metal rods and a cylindrical forward end portion of the linear motion member are dimensioned such that a predetermined clearance is provided between an inner circumference of the heating cylinder and an outer circumference of each of the metal rods, the cylindrical forward end portion can enter the heating cylinder, and an outer circumference of the cylindrical forward end portion is slidable relative to the inner circumference of the heating cylinder. A preheated new metal rod of a same kind as the metal rods can, therefore, be fully pushed into the heating cylinder irrespective of a fill volume into a mold.

### FIELD OF THE INVENTION

This invention relates to a molten metal molding machine for injecting and filling molten metal (metal melt) into a cavity of a mold, and especially to a molten metal molding machine equipped with a metal melting system which melts a metal material in a heating cylinder.

### DESCRIPTION OF THE RELATED ART

As molten metal molding machines of the type that a molten metal material is injected and filled in a cavity of a mold to obtain a product, cold-chamber type diecasting machines are well known. A cold-chamber type diecasting machine is equipped with a smelting furnace (crucible) for melting a metal material (for example, an Al alloy, Mg alloy or the like). The metal material, which has been molten in the smelting furnace, is metered and taken up by a ladle at every shot. The molten metal (metal melt) so taken up is poured into an injection sleeve, and by a high-speed advancement of an injection plunger, is then injected and filled in a cavity of a mold. Because the metal material (metal melt) which has been molten in the smelting furnace is taken up by the ladle and conveyed in the cold-chamber type diecasting machine (diecasting machine), the whole machine is large, and moreover, a certain limitation is imposed on an improvement in product quality as the molten metal is oxidized or is lowered in temperature at a surface, where the molten metal is brought into contact with air, when the molten metal is taken up and conveyed by the ladle.

A molten metal molding machine has, therefore, been proposed, which without using any smelting furnace for melting a metal material, melts the metal material by a heating cylinder which also serves as an injection sleeve (see JP-A-2004-148391).

FIGS. 7A through 7F are schematic views, which illustrate a molten metal molding machine having substantially equivalent construction as the technique shown in JP-A-2004-148391. In FIGS. 7A through 7F, there are shown a heating cylinder 101, a nozzle (hot runner nozzle) 102 arranged on a forward end of the heating cylinder 101, band heaters 103 wrapped on and around an outer circumference of the heating cylinder 101 and an outer circumference of the nozzle 102, a cavity 104 defined by an unillustrated mold and maintained in communication with a free end of the nozzle 102, an oxide-film scraper section (die section) 105 arranged on a rear end of the heating cylinder 101, an on/off valve 106 arranged through a circumferential wall of the heating cylinder 101 at a position adjacent to the rear end of the heating cylinder 101 such that, when the on/off valve 106 assumes an open position, a bore of the heating cylinder 101 is brought into communication with a vacuum pump 107 which is in communication with a hollow portion of the on/off valve 106 and is adapted to bring the bore of the heating cylinder 101 into a substantially vacuum condition, a pressure gauge 108 for checking a vacuum level inside the heating cylinder 101, an air supply 109, a solenoid valve 110 for on/off controlling the on/off valve 106 by an air pressure from the air supply 109, a material-receiving section 111 arranged opposite to an opening formed at the rear end of the heating cylinder 11, and a piston member 112 drivable by an unillustrated hydraulic cylinder such that the piston member 112 is selectively movable forward or backward through the material-receiving section 111 and the heating cylinder 101.

Referring to FIGS. 7A through 7F, a description will next be made of a molding operation by the molten metal molding machine. As illustrated in FIG. 7A, preheated metal rods 113 of a predetermined length are firstly dropped and fed one after one into the material-receiving section 111 from an unillustrated preheating apparatus, which is arranged above the material-receiving section 111 and stores the metal rods 113 of the predetermined length in a vertical line. At this stage, a predetermined number of metal rods 113 have been pushed beforehand into the heating cylinder 101 by the piston member 112 such that, through the heating cylinder 101 and nozzle 102, the metal rods 113 are filled one by one from the side of the nozzle 102. As each metal rod 113 is fed from a position close to the rear end of the heating cylinder 101 toward the nozzle 102, it is gradually molten. Inside the nozzle 102, the metal rod 113 is in a fully-molten state. For the sake of clarification, this fully-molten metal rod 113 may hereinafter be referred to as “the molten metal material 113” or simply, as “the metal material 113”. At this stage, the on/off valve 106 is in a closed position.

As depicted in FIG. 7B, the piston member 112 is next caused to advance at a low speed such that the metal rod 113 is pushed from the material-receiving section 111 into the rear end of the heating cylinder 101. Upon this push-in operation, an oxide film is scraped from an outer circumferential surface of the metal rod 113 at the oxide-film scraper section 105. When the metal rod 113 enters at least at a part thereof the heating cylinder 101 from the material-receiving section 111, the opening formed at the rear end of the heating cylinder 101 is closed by the metal rod 113. In this state, the advancement of the piston member 112 is once stopped. The on/off valve 106 is then switched into the open position by the solenoid valve 110 to bring the bore of the heating cylinder 101 into communication with the vacuum pump 107, and the bore of the heating cylinder 101 is brought into a substantially vacuum condition by the vacuum pump 107.

After the bore of the heating cylinder 101 has been brought into the substantially vacuum condition, the on/off valve 106 is next switched into the closed position by the solenoid valve 110 to cause the piston member 112 to advance at a high speed, as illustrated in FIG. 7C. As a result, the metal rod 113, which has been pushed by the piston member 112 and newly charged into the heating cylinder 101, successively pushes the preceding metal rods 113 forward. By this pushing, an injection of the molten metal material (metal melt) 113 from the nozzle 102 into the cavity 104 is rapidly initiated as depicted in FIG. 7D.

When the injection (injection and filling) has been completed with the metal material 113 being fully filled to every corner in the cavity 104 as illustrated in FIG. 7E, a pressure which the piston member 112 receives from the metal rods 113 increases to a predetermined value. Responsive to a detection of the pressure, the advancement of the piston member 112 is stopped.

Upon completion of the injection of the metal material 113 into the cavity 104, heat is absorbed into the mold from the metal material 113 in the cavity 104 so that the metal material 113 in the cavity 104 is rapidly cooled and solidified. In this cooling step, the heating control by the band heater 103 wrapped on and around the nozzle 1.02 is interrupted so that on the side of the free end of the nozzle 102, the metal material 113 in the nozzle 102 is also cooled and solidified. As a result, the nozzle 102 is sealed at the free end thereof with the thus-solidified metal material 113. After the completion of the injection, the piston member 112 is driven to retract to a position where a new metal rod 113 can be dropped and fed into the material-receiving section 111 as depicted in FIG. 7F. Upon completion of the cooling and solidification step, mold opening is performed. The solidified product (casting) is cut off from the metal material on the side of the nozzle 102 (at this stage, the nozzle 102 is heated before the mold opening to facilitate the cut-off), and together with a movable mold (not shown), the solidified product is separated from a stationary mold (not shown). After the completion of the mold opening or in the course of the mold opening, the product is ejected from the movable mold by an unillustrated ejection mechanism and is taken out by an unillustrated robot.

The molten metal molding machine, which has been described above with reference to FIGS. 7A through 7F, melts the metal rods by the heating cylinder 101, which also serves as an injection sleeve, and directly injects and fills the molten metal (metal melt) from the nozzle 102, which is arranged on the free end of the heating cylinder, into the cavity of the mold. Compared with a molten metal molding machine of the construction that at every shot, a metal material molten in a smelting furnace is metered and taken up by a ladle and is then poured into an injection sleeve as in a cold-chamber diecasting machine equipped with a smelting furnace, the above-described molten metal molding machine does not require any large smelting furnace, and as a whole, can be designed relatively compact. It is also considered that the molten metal is not prone to oxidation as there is not much risk for the molten metal to be brought into contact with air.

With the molten metal molding machine shown in FIGS. 7A through 7F, however, the response of the metal material 113 in the nozzle 102 to melting and solidification deteriorates unless the diameter of the land portion of the nozzle 102 arranged on the free end of the heating cylinder 101 is set at a certain small value or less. If the diameter of the land portion of the nozzle 102 is small, however, a problem is developed as will be described next. In the injection and filling of a molten metal, the flow velocity of the molten metal through a gate portion or runner portion of a mold is considered to be set generally at 55 m/sec or lower, preferably at from 30 to 40 m/sec from the viewpoint of avoidance of seizure and a pressure loss. The flow volume of the molten metal per unit time is the product of the cross-sectional area of the land portion of the nozzle 102 and the flow velocity. Because the diameter of the land portion of the nozzle 102 is small and as mentioned above, a limitation is imposed on the flow velocity, the flow volume, in other words, the fill volume of the molten metal per unit time is obviously limited. In the molding of a molten metal, the molten metal is rapidly cooled and solidified subsequent to its filling in a cavity as described above. Accordingly, the filling time is generally extremely short, for example, 0.1 to 0.05 second or so. For the reasons mentioned above, a limitation is naturally imposed on the weight of a product moldable (castable) by a molten metal molding machine such as that illustrated in FIGS. 7A through 7F, although it is equipped with sufficient metal-melting capacity.

In this respect, cold-chamber diecasting machines (molten metal molding machines) are superior in versatility because they make it possible to set the injection/filling velocity and the runner flow area at optimal values depending upon each product.

In Japanese Patent Application 2005-223038, the assignee of the present invention, therefore, proposed a molten metal molding machine equipped not only with the merits of the construction that a metal material is molten by a heating cylinder without using a smelting furnace but also with the merits of cold-chamber diecasting machines. In the molten metal molding machine proposed in Japanese Patent Application 2005-223038, molten metal is downwardly fed and poured from a nozzle section arranged at a forward end of a heating cylinder into an injection sleeve, and the molten metal fed into the injection sleeve is injected and filled into a mold by an injection plunger, thereby realizing both of the merits of the construction that a metal material is molten by a heating cylinder and the merits of cold-chamber diecasting machines.

In the above-described molten metal molding machine proposed in Japanese Patent Application 2005-223038 or the molten metal molding machine disclosed in JP-A-2004-148391 referred to in the above, the pushed distance of the preheated metal rod into the heating cylinder is controlled variably in accordance with the fill volume of the molten metal into the mold. The filling of a small volume of molten metal into the mold, therefore, involves a problem that a newly charged (inserted) metal material cannot be pushed fully into the heating cylinder, a portion of the metal material is exposed for along time to air, and therefore, oxidation proceeds to a serious extent, and also a problem that a portion of the metal material is exposed for a long time to air and its temperature drops. In the molten metal molding machine proposed in Japanese Patent Application 2005-223038 or the molten metal molding machine disclosed in JP-A-2004-148391, the fill volume of molten metal into the mold is limited to or smaller than the volume of one of the metal rods, and therefore, no consideration was made to set the fill volume of molten metal into the mold at a volume greater than the volume of one of the metal rods.

In Japanese Patent Application 2005-372677, the assignee of the present invention, therefore, proposed a construction that, in a molten metal molding machine of the construction that a metal material is molten by a heating cylinder without using a smelting furnace, can avoid the occurrence of the inconvenience that a portion of a newly charged metal rod is exposed for a long time to air, and can set a fill volume of molten metal into a mold at a volume greater than the volume of one metal rod.

The molten metal molding machine disclosed in JP-A-2004-148391, Japanese Patent Application 2005-223038 or Japanese Patent Application 2005-372677 takes the construction that an oxide-film scraper section formed of a die is arranged on the side of the rear end of the heating cylinder. This construction was adopted under the premise that an oxide film exists on the outer circumference of each metal rod. The potential risk of oxidation of each metal rod can be substantially eliminated, for example, provided that metal rods are promptly taken one after one by a robot from a preheating apparatus maintained under an inert gas atmosphere and are promptly and fully pushed into the heating cylinder. The arrangement of the oxide-film scraper section, which is formed of the die, on the side of the rear end of the heating cylinder as described above is, however, accompanied by problems such that (1) the push speed of each metal rod into the heating cylinder cannot be increased, (2) the oxide-film scraper section requires replacements as abrasion takes place there, and (3) the heating cylinder cannot be substantially sealed on the side of its rear end from the external air by a cylindrical forward end portion of the linear motion member, because the cylindrical forward end portion of the linear motion member can enter the heating cylinder and a clearance is provided between the outer circumference of the cylindrical forward end portion and the inner circumference of the heating cylinder to avoid the cylindrical forward end portion from being chipped off at the oxide-film scraper section.

### SUMMARY OF THE INVENTION

With the foregoing problems in view, the present invention has as an object thereof the elimination of the problems, which are caused due to the existence of the die, by adopting a construction that does not include any oxide-film scraper section (die) on the side of the rear end of the heating cylinder in the a molten metal molding machine equipped with the merits of Japanese Patent Application 2005-223038 and Japanese Patent Application 2005-372677 referred to in the above.

To achieve the above-described object, the present invention provides, in one aspect thereof, a molten metal molding machine provided with a heating cylinder, a linear motion member for successively feeding preheated metal rods into the heating cylinder from a rear end thereof to successively push the metal rods toward a forward end of the heating cylinder, and a heater arranged on the heating cylinder such that the metal rods are gradually molten as the metal rods move through the heating cylinder from the rear end thereof toward the forward end thereof, wherein:

the heating cylinder, the metal rods and a cylindrical forward end portion of the linear motion member are dimensioned such that a predetermined clearance is provided between an inner circumference of the heating cylinder and an outer circumference of each of the metal rods, the cylindrical forward end portion can enter the heating cylinder, and an outer circumference of the cylindrical forward end portion is slidable relative to the inner circumference of the heating cylinder,

whereby a preheated new metal rod of a same kind as said metal rods can be fully pushed into the heating cylinder irrespective of a fill volume into a mold.

The cylindrical forward end portion of the linear motion member may preferably remain in the heating cylinder except when feeding of the preheated new metal rod into the heating cylinder is performed.

Preferably, a rear-end bore section of the heating cylinder may be maintained under an inert gas atmosphere.

Preferably, the molten metal molding machine may further comprises a nozzle section arranged on a side of a front end of the heating cylinder, an injection sleeve into which molten metal is downwardly fed and poured from the nozzle section, and an injection plunger for injecting and filling the molten metal, which has been fed into the injection sleeve, into the mold.

Further, a push stroke of the linear motion member for the pouring may preferably be set longer than an overall length of one of the metal rods.

In the molten metal molding machine according to the present invention, the heating cylinder, the metal rods and the cylindrical forward end portion of the linear motion member are dimensioned such that a predetermined clearance is provided between the inner circumference of the heating cylinder and the outer circumference each of the metal rods, the cylindrical forward end portion can enter the heating cylinder, and the outer circumference of the cylindrical forward end portion is slidable relative to the inner circumference of the heating cylinder, and therefore, a preheated new metal rod of a same kind as the metal rods can be fully pushed into the heating cylinder irrespective of a fill volume into a mold. Different from the conventional molten metal molding machines, no large resistance is thus produced at the point of entrance into the heating cylinder upon pushing each metal rod into the heating-cylinder. Accordingly, each metal rod can be pushed smoothly at high speed into the heating cylinder so that the push speed can be increased. Moreover, even when the fill volume of molten metal into the mold is small, the molten metal molding machine according to the present invention does not develop the inconvenience that a portion of a newly charged metal rod would be exposed for a long time to air as in the conventional molten metal molding machines. The molten metal molding machine according to the present invention, therefore, can substantially lessen the potential risk that a new metal rod may be oxidized and can also eliminate the potential risk that the temperature of the new metal rod may be lowered. Owing to the construction that practically no clearance is formed between the inner circumference of the heating cylinder and the outer circumference of the cylindrical forward end portion of the linear motion member, the heating cylinder can be substantially sealed on the side of the rear end thereof from the external air by the cylindrical forward end portion of the linear motion member by controlling the cylindrical forward end portion of the linear motion member to remain within the heating cylinder except when the feeding of the new metal rod is performed. As a consequence, it is possible to substantially prevent oxidation of the metal material in the heating cylinder. As the newly charged metal rod is designed to be fully pushed into the rear-end bore section of the heating cylinder, said rear-end bore portion being maintained under the inert gas atmosphere, the metal material pushed in the heating cylinder can be protected free from the potential risk of oxidation. It is also possible to make the pouring push stroke of the linear motion member longer than the overall length of one metal rod in the molten metal molding machine equipped with both of the merits of the construction that a metal material is molten by a heating cylinder without using any smelting furnace and the merits of the cold-chamber type diecasting machines. As in Japanese Patent Application 2005-372677 referred to in the above, it is accordingly also possible to readily cast even such a heavy and large product that the fill volume of molten metal into a mold exceeds the volume of one metal rod.

### BRIEF DESCRIPTION OF THE DRAWINGS

FIG. 1 is a simplified cross-sectional view of a molten metal molding machine according to one embodiment of the present invention at a stage that a linear motion member is at a most retracted position and a preheated metal rod is about to be newly fed to a position opposite to an opening formed at a rear end of a heating cylinder.

FIG. 2 is a similar simplified cross-sectional view as in FIG. 1, but the molten metal molding machine is at a stage that a forward end portion of the metal rod has been pushed by the linear motion member into the heating cylinder through the opening formed at the rear end of the heating cylinder.

FIG. 3 is a similar simplified fragmentary cross-sectional view as in FIGS. 1 and 2, but the linear motion member has advanced further until its pushing portion (cylindrical forward end portion) enters the heating cylinder through the opening formed at the rear end of the heating cylinder, and molten metal has been downwardly fed from a nozzle section, which is arranged on a forward end of the heating cylinder, into an injection sleeve.

FIG. 4 is a similar simplified cross-sectional view as in FIGS. 1 to 3, but injection and filling of the molten metal from the injection sleeve into a cavity of a mold has been completed.

FIG. 5 is a simplified fragmentary cross-sectional view of the molten metal molding machine of FIGS. 1 through 4 at a stage that the newly fed metal rod has been fully pushed within the heating cylinder by the pushing portion of the linear motion member.

FIG. 6 is a similar simplified cross-sectional view as in FIGS. 1 to 4, and illustrates a relationship between a push stroke of the linear motion member for a single-shot pouring of the molten metal and an overall length of one of the metal rods.

FIGS. 7A through 7F are simplified fragmentary cross-sectional views of a conventional molten metal molding machine at different stages of a molten metal molding operation, respectively.

### DETAILED DESCRIPTION OF THE PREFERRED EMBODIMENT

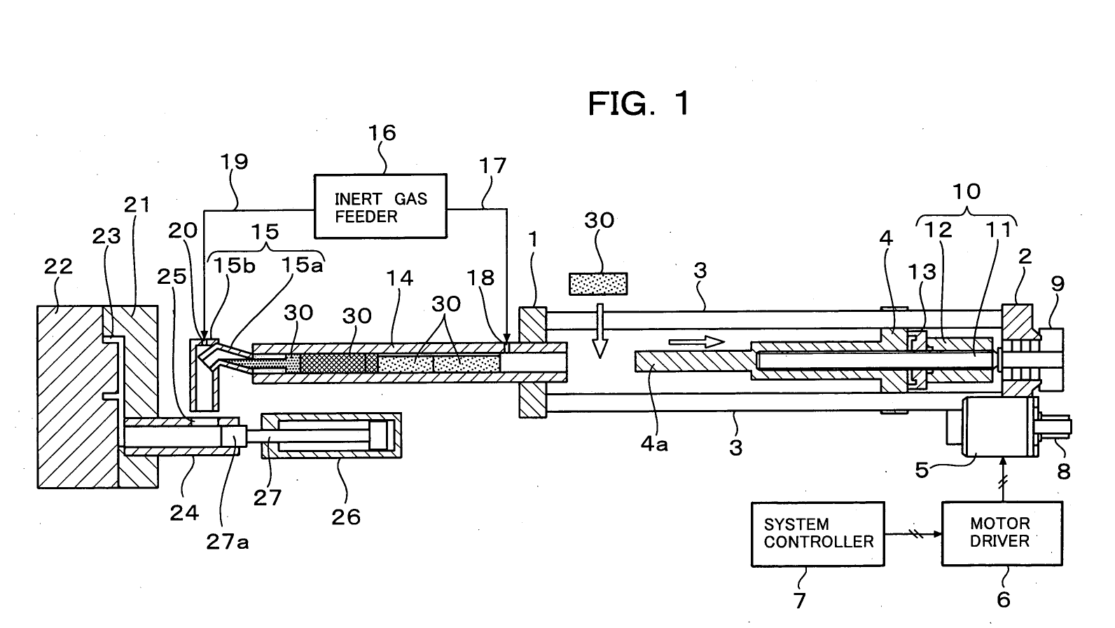

A molten metal molding machine according to an embodiment of the present invention will hereinafter be described with reference to FIGS. 1 through 6. In FIGS. 1 through 4, there are illustrated a first holding plate 1 arranged movably forward and rearward on unillustrated rail members in a melting unit, a second holding plate 2 also arranged movably forward and rearward on the unillustrated rail members in the melting unit and positioned in opposition to the first holding plate 1, a plurality of connecting shafts 3 fixed at opposite ends thereof on the first holding plate 1 and the second holding plate 2, respectively, and integrally connecting the first holding plate 1 and the second holding plate 2 together, a linear motion member 4 arranged movably forward and rearward on the unillustrated rail members in the melting unit (or arranged movably forward and rearward while being guided by the connecting shafts 3 which extend through the linear motion member 4) and driven forward and rearward between the first holding plate 1 and the second holding plate 2 as will be described subsequently herein, a metal-material-pushing, electric servomotor 5 mounted on the second holding plate 2, a motor driver 6 for driving the electric servomotor 5 under control, and a system controller 7 for governing the overall control of the molten metal molding machine. Referring to measurement information, clock information and the like from unillustrated various sensors, the system controller 7 controls operations of individual elements of the molten metal molding machine on the basis of various programs provided in advance. With reference to outputs of an unillustrated encoder arranged on the electric servomotor 5, this system controller 7 gives drive commands to the electric servomotor 5 via the motor driver 6 under speed feedback control such that the linear motion member 4 can be driven along a position axis under speed feedback control.

Also illustrated are a small driving pulley 8 fixedly secured on an output shaft of the electric servomotor 5, a driven pulley 9 to which rotation of the electric servomotor 5 is transmitted via the small driving pulley 8 and an unillustrated timing belt, a ball screw mechanism 10 equipped with a screw shaft 11 and a nut member 12 and adapted to convert rotary motion into linear motion, the screw shaft 11 rotatably held on the second holding plate 2 and carrying the driven pulley 9 fixedly secured on an end portion of the screw shaft 11, and the nut member 12 arranged in meshing engagement with the screw shaft 11, linearly movable as a result of rotation of the screw shaft 11 and fixedly secured at an end portion thereof on a load cell 13 which is in turn fixedly secured on the linear motion member 4. Rotation of the electric servomotor 5 is transmitted to the screw shaft 11 via the small driving pulley 8, the unillustrated timing belt and the driven pulley 9, and depending upon the direction of rotation of the screw shaft 11, the linear motion member 4 and the load cell 13 are driven forward or rearward together with the nut member 12.

The above-described linear motion member 4 serves to push the metal rod 30, which is before its melting to be described subsequently herein, into the bore of the heating cylinder 14 through the below-described opening at the rear end of the heating cylinder 14, and the linear motion member 4 is provided with a pushing portion 4a as a cylindrical forward end portion having an outer diameter substantially equal to the inner circumference diameter of the below-described heating cylinder 14. The outer circumference of the pushing portion 4a of the linear motion member 4, said pushing portion 4a being capable of entering the below-described heating cylinder 14, is dimensioned such that the outer circumference of the pushing portion 4a is slidable relative to the inner circumference of the heating cylinder 14. In the state that the pushing portion 4a has entered the heating cylinder 14, substantially no clearance can be left between the inner circumference of the heating cylinder 14 and the outer circumference of the pushing portion 4a of the linear motion member 4. It is, therefore, possible to substantially seal the rear-end-side of the heating cylinder 14 from the external air by the pushing portion 4a. In this embodiment, the linear motion member 4 is controlled such that its pushing portion 4a is located in the heating cylinder 14 except when the feeding of the new metal rod 30 into the heating cylinder 14 is performed as will be described subsequently herein. This embodiment is also designed such that by the pushing portion 4a of the linear motion member 4, the metal rod 30 before its melting to be described subsequently herein can be fully pushed into the bore of the below-described heating cylinder 14 irrespective of the pour volume as will be described subsequently herein.

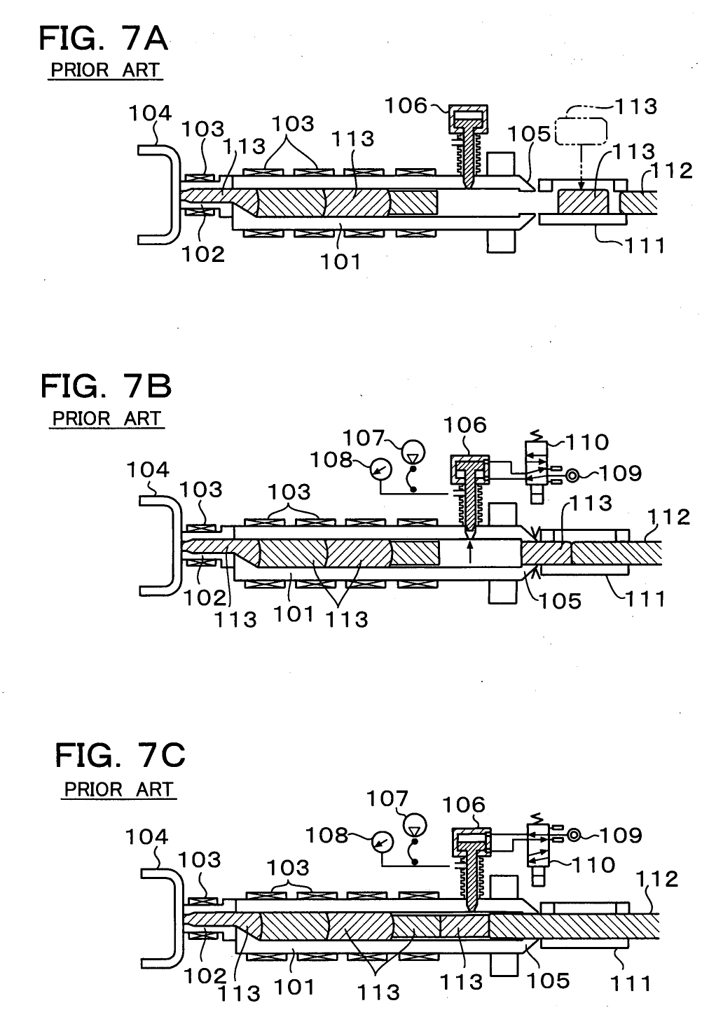

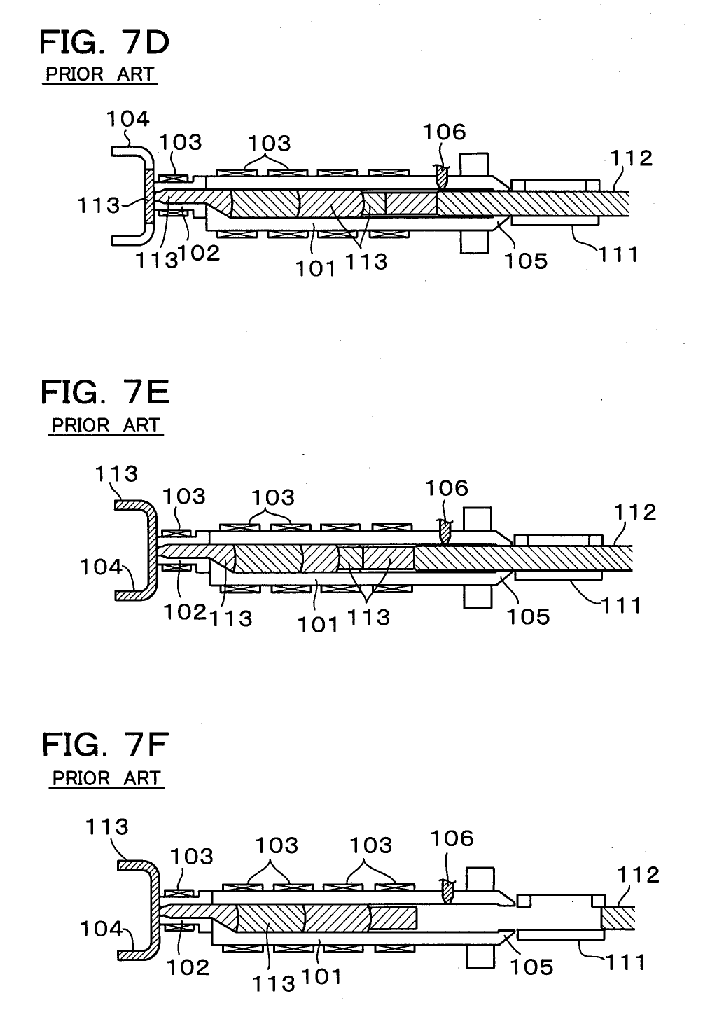

Further illustrated is the heating cylinder 14 fixed at a rear end thereof on the first holding plate 1. Different from conventional heating cylinders such as that described above, the heating cylinder 14 in this embodiment takes the construction that it does not include any die (oxide-film scraper section) on the side of its rear end. The dimension of the inner circumference diameter of the heating cylinder 14 is set to have a predetermined amount of clearance between the inner circumference of the heating cylinder 14 and the outer circumference of the below-described metal rod 30, and is also set substantially equal to the dimension of the outer circumference diameter of the pushing portion 4a of the linear motion member 4. Numeral 15 indicates a nozzle section arranged on a forward end of the heating cylinder 14 integrally with the heating cylinder 14. The nozzle section 15 is composed of a substantially “inverted, open V-shaped” first nozzle portion 15a and a second nozzle portion 15b. The first nozzle portion 15a is arranged on the free end of the heating cylinder 14, and is equipped with an upwardly tilted, pipe portion and a downwardly titled, pipe portion extending in continuation with the upwardly tilted, pipe portion. The second nozzle portion 15b, on the other hand, is composed of a vertical pipe, which encloses therein a front end portion of the first nozzle portion 15a such that molten metal delivered from the heating cylinder 14 via the first nozzle portion 15a is downwardly fed into an injection sleeve 24 to be described subsequently herein. Although illustration is omitted in the drawings, band heaters are also wrapped on and around the outer circumferences of the heating cylinder 14 and nozzle section 15 as in the construction of FIGS. 7A through 7F.

Still further illustrated are an inert gas feeder 16 for feeding inert gas (for example, nitrogen gas), which has been pressurized (specifically, to a pressure of such a level as sufficiently exceeding the atmospheric pressure), into the rear-end bore section of the heating cylinder 14 and the nozzle section 15, a gas line 17 for feeding the inert gas from the inert gas feeder 16 into the rear-end bore section of the heating cylinder 14 through a gas feed port 18 arranged through a circumferential wall of the heating cylinder 14 at the position of the rear end thereof, and another gas line 19 for feeding the inert gas from the inert gas feeder 16 into the interior of the nozzle section 15 through another gas feed port 20 arranged through a top wall of the nozzle section 15. The inert gas feeder 16 is controlled by the system controller 7, and normally feeds the pressurized inert gas into the rear-end bore section of the heating cylinder 14 and the nozzle section 15.

Still further illustrated are a stationary mold 21 and a movable mold 22. Although illustration is omitted in the drawings, the stationary mold 21 is mounted on a stationary die plate while the movable mold 22 is mounted on a movable die plate which is selectively movable forward or rearward. By a forward movement or rearward movement of the movable die plate, the movable mold 22 performs mold closing or mold opening, and upon completion of the mold closing, a cavity 23 is defined by the stationary mold 21 and the movable mold 22.

Yet further illustrated are the injection sleeve 24 fixed at a forward end thereof on the stationary mold 21, a molten-metal pour hole 25 formed through a circumferential wall of the injection sleeve 24 at a top thereof such that the molten-metal pour hole 25 is located opposite an opening in a free end (lower opening) of the nozzle section 15, a hydraulic cylinder 26 for injecting and filling the molten metal, and an injection plunger 27 selectively movable forward or rearward through the injection sleeve 24. For the convenience of simplifying the illustration in the drawings, the injection plunger 27 is illustrated as one integrated with a piston rod of the hydraulic cylinder 26. Actually, however, a rod portion of the injection plunger 27, said rod portion having a plunger tip 27a, is connected to and fixed with a free end of the piston rod of the hydraulic cylinder 26. The hydraulic cylinder 26 is controlled by the system controller 7 via an unillustrated control valve and valve driver to selectively move the injection plunger 27 forward or rearward.

Numeral 30 designates metal materials. It is to be noted that in FIGS. 1 through 6, metal rods before their melting, metal rods in their partially molten states, and the molten metal material are collectively designated by numeral 30. It is also to be noted that in the respective drawings, the metal materials 30 shown darkest indicate a molten state, the metal materials 30 shown by meshing patterning indicate a partially-molten state, and the metal materials 30 shown by adding dots indicate a solidified state

With reference to FIGS. 1 through 4, a description will next be made about an operation of the molten metal molding machine according to this embodiment. In this embodiment, control is effected by the system controller 7 such that the pushing portion 4a of the linear motion member 4 remains in the heating cylinder 14 except when the feeding of the new metal rod 30 is performed. Upon arrival at a timing immediately before pushing and feeding the new metal rod 30 into the heating cylinder 14, the linear motion member 4 is driven to retract such that the linear motion member 4 is positioned at its most retracted position. In synchronization with this retraction of the linear motion member 4 and responsive to a command from the system controller 7, an unillustrated material-feeding robot promptly takes out and conveys a preheated metal rod 30 of a predetermined length from an unillustrated preheating apparatus an interior of which is maintained under an inert gas atmosphere, and positions it to oppose the opening formed at the rear end of the heating cylinder 14. As shown in FIG. 1, parts of the heating cylinder 14 and nozzle section 15 are filled at this stage with a predetermined number of metal rods 30, which have been pushed beforehand into the heating cylinder 14 by the pushing portion 4a of the linear motion member 4, from the upwardly tilted pipe portion of the substantially “inverted, open V-shaped” first nozzle portion 15a to an intermediate position in the heating cylinder 14 (to a position adjacent the rear end of the heating cylinder 14). As each metal rod 30 advances from the position adjacent to the rear end of the heating cylinder 14 toward the nozzle section 15, the metal rod 30 is gradually molten, and in the nozzle section 15 (the upwardly tilted pipe portion of the first nozzle portion 15a), the metal material 30 is in a fully-molten state. At this time, the injection plunger 27 is at its most-retracted position. As mentioned above, pressurized inert gas is normally fed from the inert gas feeder 16 into the rear-end bore section of the heating cylinder 14, and therefore, the rear-end bore section of the heating cylinder 14 is filled with the inert gas. Further, the pressurized inert gas is also normally fed from the inert gas feeder 16 into the second nozzle portion 15b of the nozzle section 15, and therefore, the interior of the nozzle section 15 is also filled with the inert gas.

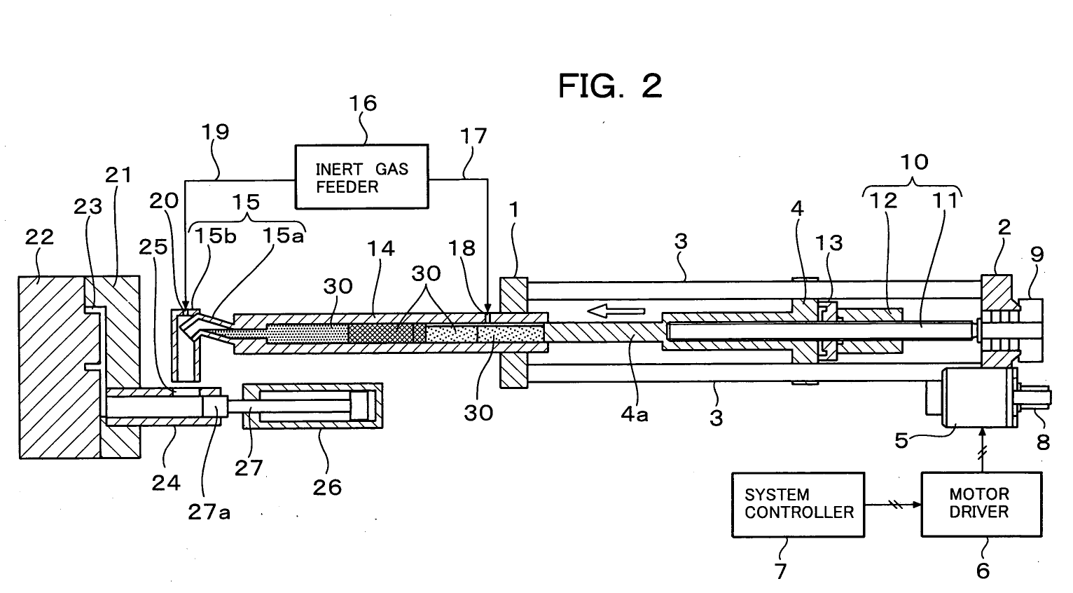

When the metal rod 30 held by the unillustrated material-feeding robot is positioned to oppose the opening at the rear end of the heating cylinder 14 as described above, the unillustrated material-feeding robot, responsive to another command from the system controller 7, immediately reduces its holding force for the metal rod 30, and places the metal rod 30 in a state ready for being pushed (needless to say, the positioning accuracy for the metal rod 30 is maintained at this time). Responsive to a further command from the system controller 7, the electric servomotor 5 is caused to rotate in a predetermined direction via the motor driver 6 such that the linear motion member 4 is caused to advance to push the metal rod 30 by the pushing portion 4a of the linear motion member 4 into the heating cylinder 14 through the opening formed at the rear end of the heating cylinder 14 as illustrated in FIG. 2. This pushing is promptly performed such that the metal rod 30 is fully pushed into the heating cylinder 14 irrespective of the pour volume in each one-shot molding operation. Described specifically, instead of pushing the newly charged metal rod into the heating cylinder over a stroke corresponding to the pour volume (the fill volume into the mold) as in JP-A-2004-148391 referred to in the above, the newly charged metal rod 30 is fully pushed into the heating cylinder 14, which is normally filled with inert gas, irrespective of the pour volume in this embodiment. In the conventional art such as JP-A-2004-148391, a small pour volume may cause the problem that a newly charged metal rod is not fully pushed into a heating cylinder, and a part of the metal rod is exposed for a long time to air and is subjected to oxidation to a serous extent or a part of the metal rod is exposed for a long time to air and is lowered in temperature. Such a problem, however, does not occur at all in this embodiment. Further, in this embodiment, the heating cylinder 14 takes the construction that no die (oxide-film scraper section) is arranged on the side of the rear end of the heating cylinder 14, and the predetermined amount of clearance is provided between the inner circumference of the heating cylinder 14 and the outer circumference of each metal rod 30. Different from the conventional art, no large resistance is, therefore, produced at the point of entrance into the heating cylinder 14 upon pushing the metal rod 30 into the heating cylinder 14, and moreover, the push speed can be increased. Even taking this advantage alone, this embodiment can contribute to the prevention of oxidation of the metal material 30, and can also shorten the molding cycle to an extent commensurate with the increase in push speed.

When the newly charged metal rod 30 is brought into such a state that it has been fully pushed within the heating cylinder 14, the heating cylinder 14 is in such a state that it is substantially sealed on the side of its rear end from the external air by the pushing portion 4a of the linear motion member 4. It is, therefore, possible to practically prevent oxidation of the metal material 30 in the heating cylinder 14. This embodiment is constructed to form substantially no clearance between the inner circumference of the heating cylinder 14 and the outer circumference of the pushing portion 4a of the linear motion member 4. This embodiment also takes the construction that the inner circumference of the heating cylinder 14 and the outer circumference of the pushing portion 4a of the linear motion member 4 are in such a relationship as observed between a linear bearing and a member linearly movable while being guided by the linear bearing. It is, therefore, hard to conclude that this embodiment is completely air tight between them. Nonetheless, the pressurized inert gas is normally fed into the rear-end bore section of the heating cylinder 14, and therefore, absolutely no air is allowed to enter the rear-end bore section of the heating cylinder 14 although the inert gas may slightly leak out between the inner circumference of the heating cylinder 14 and the outer circumference of the pushing portion 4a of the linear motion member 4. With the pushing portion 4a of the linear motion member 4 having entered the heating cylinder 14, it is, therefore, sufficient to feed the inert gas only at a very low flow rate into the rear-end bore section of the heating cylinder 14. This makes it possible to save the inert gas accordingly.

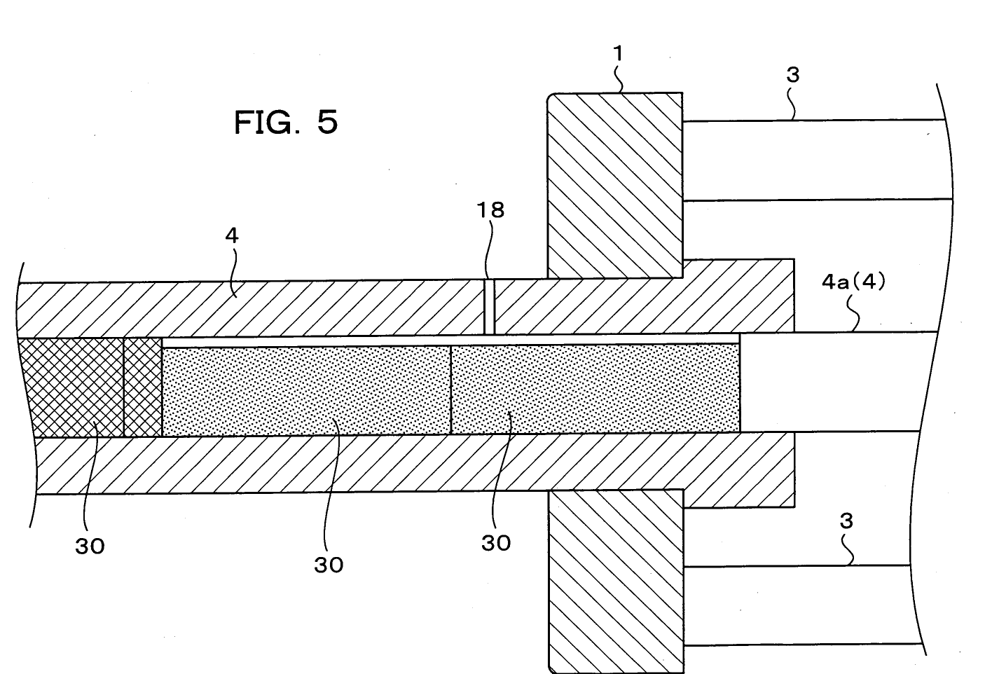

FIG. 5 is a fragmentary cross-sectional view illustrating the state that the metal rod 30 newly charged by the pushing portion 4a of the linear motion member 4 has been fully pushed within the heating cylinder 14. As shown in the drawing, the pushing portion 4a of the linear motion member 4 has entered the heating cylinder 14 to establish a state that substantially no clearance exists between the inner circumference of the heating cylinder 14 and the outer circumference of the pushing portion 4a of the linear motion member 4.

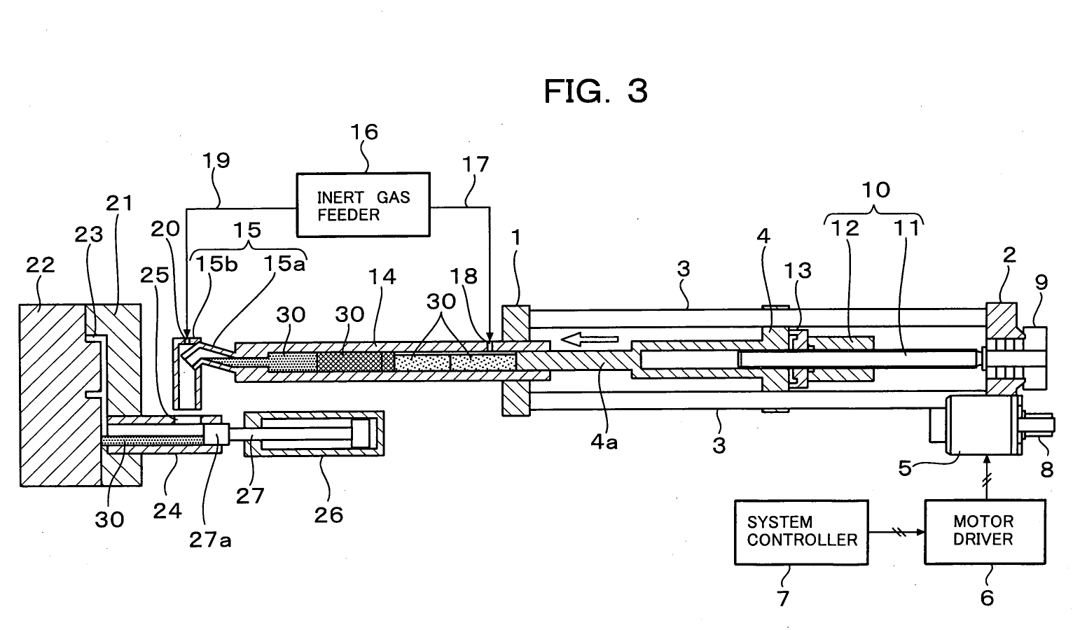

When the linear motion member 4 is further driven forward responsive to a still further command from the system controller 7 after the newly charged metal rod 30 has been fully pushed into the heating cylinder 14, the metal rod 30 newly charged as a result of the pushing by the pushing portion 4a of the linear motion member 4 is brought into contact with the preceding metal rod 30. When the linear motion member 4 is further driven forward, the newly charged meal rod 30 successively pushes the preceding metal rods 30 forward. As illustrated in FIG. 3, this pushing causes the molten metal 30 (the molten metal material (metal melt) 30) to be delivered from the nozzle section 15 and then to be quickly and downwardly fed (in other words, poured) into the injection sleeve 24 from the molten metal pour hole 25 of the injection sleeve 24.

The pour volume of the molten metal 30 into the injection sleeve 24 is, of course, determined by the advance stroke of the linear motion member 4 after the newly charged metal rod 30 is brought into contact with the preceding metal rod 30. In this embodiment, it is designed to assure complete pushing of the newly charged metal rod 30 into the heating cylinder 14 by a single pushing operation of the linear motion member 4. When a single pour volume is smaller than the volume of one of the metal rods 30, for example, is a half of the volume of one of the metal rods 30, the pushing of the new metal rod 30 into the heating cylinder 14 is performed once every two pouring operations. In this case, the pushing portion 4a of the linear motion member 4 is designed to remain standstill within the heating cylinder 14 from the completion of the first pouring operation of the two pouring operations until the initiation of the next pouring operation. When the pour volume in each single-shot molding operation is conversely greater than the volume of one of the metal rods 30, for example, is twice as much as the volume of one of the metal rods 30, it is designed to continuously perform pushing of two new metal rods 30 into the heating cylinder per every pouring operation. As described above, the molten metal molding machine of this embodiment is constructed to readily meet even such a case that a single pour volume exceeds the volume of one of the metal rods 30. The molten metal molding machine of this embodiment can, therefore, readily cast even heavy and large products.

When the molten metal 30 has been poured as much as needed for a single shot into the injection sleeve 24, the forward drive of the linear motion member 4 is stopped as described above. The above-described pouring of the molten metal 30 into the injection sleeve 24 is performed at a high-speed. This high-speed pouring is achieved by driving the electric servomotor 5 under predetermined speed feedback control such that the linear motion member 4 moves forward at a speed commensurate with its stroke (position). Because, as described above, the electric servomotor 5 is used as a drive supply for the linear motion member 4 and the electric servomotor 5 is subjected to the speed feedback control in accordance with the stroke of the linear motion member 4, the advanced position of the linear motion member 4 can be accurately controlled, thereby making it possible to stabilize the volume of the molten metal 30 to be delivered as much as needed for a single shot from the nozzle section 15.

Further, the pressurized inert gas is continuously fed into the nozzle section 15 from the gas feed port 20 formed through the top wall of the nozzle section 15 so that the nozzle section 15 is filled with the inert gas, and the inert gas is also fed from the opening in the free end of the nozzle section 15 into the injection sleeve 24 through the molten metal pour port 25. The injection sleeve 24 is, therefore, also filled with the inert gas so that the metal material remains absolutely free from the potential risk of oxidation even in the course of the above-described pouring of the molten metal 30 into the injection sleeve 24.

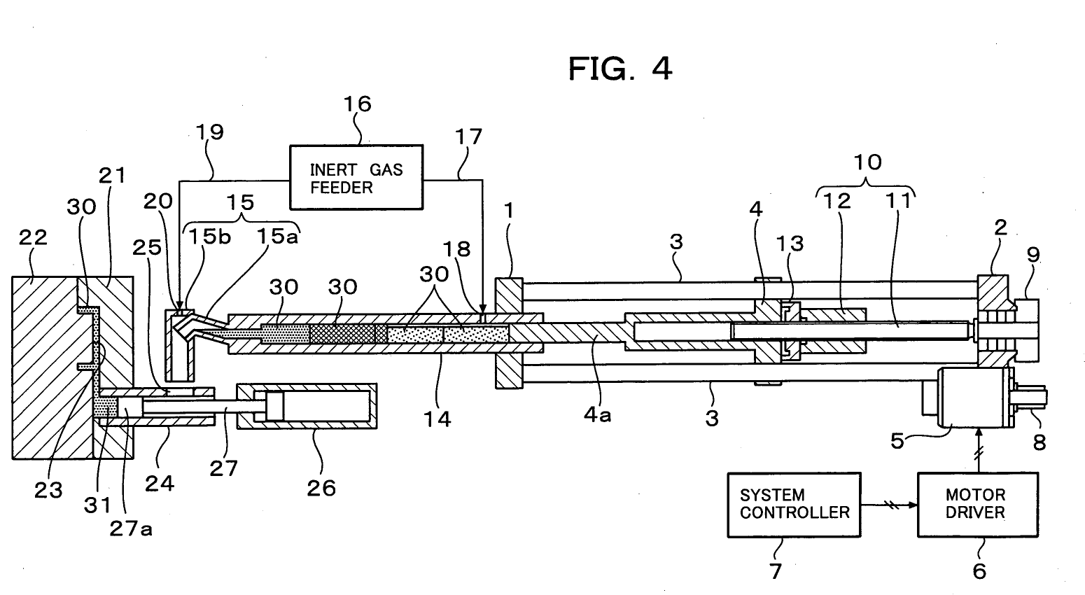

Upon completion of the feeding of the molten metal 30 into the injection sleeve 24 as much as needed for a single shot, the hydraulic cylinder 26 is immediately driven and controlled by a yet further command from the system controller 7. Described specifically, the injection plunger 27 is firstly driven forward at a low speed to perform gas venting in a known manner. Subsequently, the injection plunger 27 is driven forward at a high speed so that the molten metal 30 is rapidly injected and filled from the injection sleeve 24 into the cavity 23. FIG. 4 illustrates the state that the filling of the molten metal 30 into the cavity 23 has been completed.

The above-described injection and filling of the molten metal 30 into the cavity 23 results in the molding (casting) of molten metal in a similar manner as in the molding (casting) of molten metal by a cold-chamber diecasting machine. Different from the conventional molten metal molding machine shown in FIGS. 7A through 7F, it is, therefore, possible to optimize the injection or filling speed and the flow area of the runner depending upon each product. Accordingly, the molten metal molding machine according to this embodiment is excellent in versatility, and can also cast even heavy products. In addition, this embodiment can also cast still larger and heavier products because the casting of such products as requiring a single pour volume greater than the amount of one of the metal rods 30 is also feasible. Further, the adoption of the cold-chamber control method, which has been widely used for many years, can also stabilize the injection or filling operation. In cold-chamber molding (casting) of molten metal, a biscuit (in FIG. 4, numeral 31 indicates a biscuit) connected to a casting is also taken out at the same time as the casting is taken out of a mold. The molten metal 30 is, therefore, allowed to remain as a fresh material not subjected to the heat cycle of heating→cooling→heating (not exposed to any long heat history), thereby making it possible to contribute to an improvement in the quality of casting.

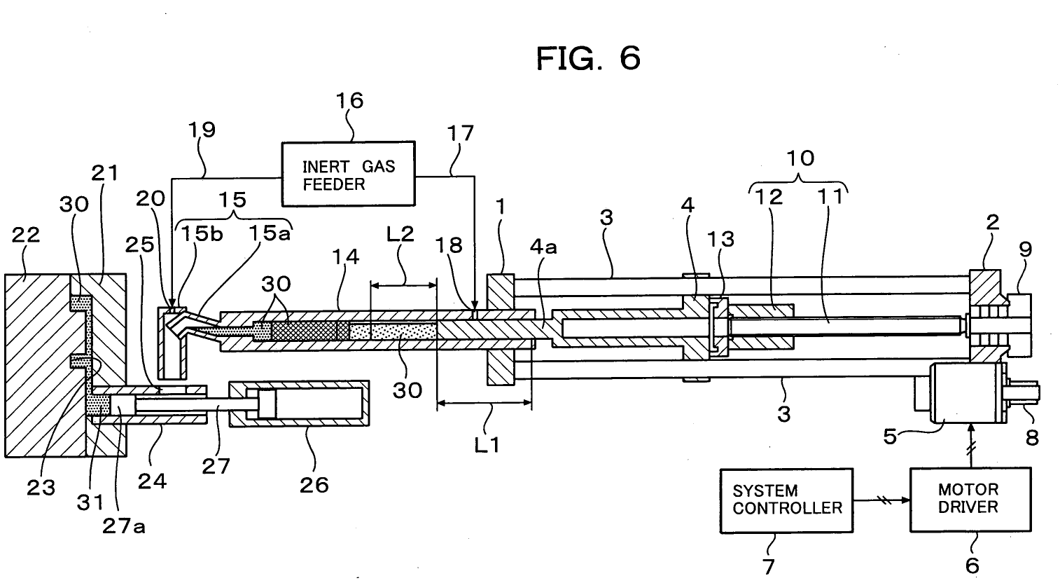

FIG. 6 illustrates, for the sake of reference, the manner of casting when the pour volume in each single-shot molding operation is set greater than the volume of one of the metal rods 30 by setting the push stroke L1 for the linear motion member 4 in each pouring operation is set longer than the overall length L2 of one of the metal rods 30.

This embodiment is directed to a molten metal molding machine equipped with both of the merits of the construction that the metal material 30 is molten by the heating cylinder 14, i.e., no need for the use of a smelting furnace and the feasibility of construction of the whole machine in a compact design and the merits of cold-chamber type diecasting machines, i.e., excellent versatility and the feasibility of molding (casting) even heavy products. As appreciated from the foregoing, this embodiment is constructed to fully push the new metal rod 30 into the heating cylinder 14 irrespective of the fill volume into the mold by forming the heating cylinder 14 into the construction provided on the side of its rear end with no oxide-film scraper section (die), providing a predetermined amount of clearance between the inner circumference of the heating cylinder 14 and the outer circumference of each metal rod 30, and allowing the outer circumference of the pushing portion 4a of the linear motion member 4, said pushing portion being capable of entering the heating cylinder 14, to slide relative to the inner circumference of the heating cylinder 14. Different from the conventional art, no large resistance is, therefore, produced at the point of entrance into the heating cylinder 14 upon pushing each metal rod 30 into the heating cylinder 14. Accordingly, each metal rod 30 can be pushed smoothly at high speed into the heating cylinder 14, and the push speed can be increased. Moreover, even when the fill volume of the molten metal 30 into the mold is small, this embodiment does not produce the inconvenience that as in the conventional art, a portion of each newly charged metal rod is exposed for a long time to air. This has made it possible to substantially reduce the potential risk of oxidation of the new metal rod 30 and also the potential risk of a reduction in the temperature of the new metal rod 30. This embodiment is also constructed to form substantially no clearance between the inner circumference of the heating cylinder 14 and the outer circumference of the pushing portion 4a of the linear motion member 14. By controlling the pushing portion 4a of the linear motion member 4 to remain in the heating cylinder 14 except when the feeding of the new metal rod 30 is performed, the heating cylinder 14 can be substantially sealed on the side of its rear end from the external air by the pushing portion 4a of the linear motion member 4, thereby making it possible to substantially preventing oxidation of the metal material 30 in the heating cylinder 14. As the pressurized inert gas is fed into the rear-end bore section of the heating cylinder 14, it is also possible to eliminate the potential risk that the metal material 30 in the heating cylinder 14 may be oxidized. Further, the push stroke of the linear motion member 4 for a pouring operation can be set longer than the overall length of one of the metal rods 30, thereby making it possible to readily cast such a heavy and large product as requiring a fill volume of the molten metal 30 into the mold in excess of the volume of one of the metal rods 30.

This application claims the priority of Japanese Patent Application 2006-35186 filed Feb. 13, 2006, which is incorporated herein by reference.

1. A molten metal molding machine provided with a heating cylinder, a linear motion member for successively feeding preheated metal rods into said heating cylinder from a rear end thereof to successively push said metal rods toward a forward end of said heating cylinder, and a heater arranged on said heating cylinder such that said metal rods are gradually molten as said metal rods move through said heating cylinder from said rear end thereof toward said forward end thereof, wherein:
said heating cylinder, said metal rods and a cylindrical forward end portion of said linear motion member are dimensioned such that a predetermined clearance is provided between an inner circumference of said heating cylinder and an outer circumference of each of said metal rods, said cylindrical forward end portion can enter said heating cylinder, and an outer circumference of said cylindrical forward end portion is slidable relative to said inner circumference of said heating cylinder,
whereby a preheated new metal rod of a same kind as said metal rods can be fully pushed into said heating cylinder irrespective of a fill volume into a mold.

2. A molten metal molding machine according to claim 1, wherein said cylindrical forward end portion of said linear motion member remains in said heating cylinder except when feeding of said preheated new metal rod into said heating cylinder is performed.

3. A molten metal molding machine according to claim 1, wherein a rear-end bore section of said heating cylinder is maintained under an inert gas atmosphere.

4. A molten metal molding machine according to claim 1, further comprising:
a nozzle section arranged on a side of a front end of said heating cylinder,
an injection sleeve into which molten metal is downwardly fed and poured from said nozzle section, and
an injection plunger for injecting and filling said molten metal, which has been fed into said injection sleeve, into said mold.

5. A molten metal molding machine according to claim 4, wherein a push stroke of said linear motion member for said pouring is set longer than an overall length of one of said metal rods.
